(19) United States
(12) Patent Application Publication
(10) Pub. No.: US 2013/0276312 A1
(43) Pub. Date: Oct. 24, 2013

(54) UTILITY KNIFE INCLUDING A LOCKING MECHANISM AND/OR RATCHETING MECHANISM

(71) Applicant: Seber Design Group, Inc., Vista, CA (US)

(72) Inventors: Brett P. SEBER, Vista, CA (US); Wesley James TOM, Vista, CA (US)

(21) Appl. No.: 13/919,851

(22) Filed: Jun. 17, 2013

Related U.S. Application Data
(62) Division of application No. 12/686,558, filed on Jan. 13, 2010.
(60) Provisional application No. 61/144,441, filed on Jan. 13, 2009.

(51) Int. Cl. B26B 5/00

(52) U.S. Cl. CPC B26B 5/00
USPC 30/164

(57) ABSTRACT

A utility knife includes a handle and a pivotably connected blade retainer for retaining a blade. An external, symmetrically toothed gear is fixed relative to one of the handle or the blade retainer, and a locking mechanism is associated with the other. The locking mechanism cooperates with the gear to lock the blade retainer in one of a plurality of fixed positions and includes pawls located in channels having converging ends. A manually actuable release mechanism is associated with the locking mechanism for unlocking the blade retainer to permit pivotal movement. Furthermore, a manually actuable blade release mechanism is associated with a blade locking mechanism contained in the blade retainer, for locking and releasing the blade when exchanging a dull blade for a replacement blade.

### CROSS-REFERENCE TO RELATED APPLICATIONS

This application is a divisional of co-pending U.S. patent application Ser. No. 12/686,558, filed on Jan. 13, 2010, which claims benefit of U.S. provisional application Ser. No. 61/144,441, filed on Jan. 13, 2009, the entire contents of each of which are incorporated herein by reference.

### BACKGROUND OF THE INVENTION

1. Field of the Invention

The present invention is generally directed to utility knives. More particularly, the present invention is directed to a utility knife including a locking mechanism and/or ratcheting mechanism allowing the utility knife to be secured in a plurality of positions.

2. Description of the Related Art

A utility knife is a common tool used worldwide by many to cut various items. Sometimes referred to as box cutters, utility knives are used to cut various items such as cardboard boxes, tape, paper, rope, string, drywall, carpet, plastics, composites and even some woods. The items that a utility knife can cut is virtually limitless, thus the utility moniker. Utility knives are different than pocket knives in that the blade of a utility knife is usually a razor-type blade secured within the housing of the utility knife. The razor-type knife blade is replaceable and separable from the handle of the utility knife. When a particular knife blade has dulled from repeated use, a new sharp knife blade is exchanged for the old one.

Some utility knives have included knife blades that are fixed at one end during assembly and are thereafter continuously exposed. Without a protective guard, the constantly exposed knife blade presents a continuing risk of injury to users and a continual risk of damage to objects that come in contact with the knife blade. This risk exists even when the utility knife is not in use. These fixed knife blade knives require disassembly of the knife body to remove or replace a worn out or damaged blade. During disassembly, users risk losing or damaging knife components including the handle, knife blade, or blade retaining mechanism. In some cases, reassembly is complicated and requires instruction manuals or other special tools and supplies developed by the manufacturer. Such burdens decrease the overall efficient operation, user convenience, and performance of the knife because of the additional time, money, and energy required to replace the utility blade. Disassembly and reassembly are simply an inconvenient burden placed on the end user.

In another example, the knife blade includes a continuous multiblade unit that is capable of extension beyond the end of the knife handle through the use of a button mechanism. This mechanism is incorporated into the knife blade handle and is depressed into a channel for slideably extending and retracting the multiblade unit. The individual blades are separated by scorelines located at intermittent intervals along the length of the continuous multiblade unit. Individual blades that wear out, break, or simply need replaced are separated from the continuous multiblade unit along the scorelines separating the individual blades. A new blade previously concealed within the utility knife handle replaces the old blade, once the old blade is separated. The method of replacing blades by means of breaking off worn out or broken blades certainly presents the danger of inadvertent injury to the user or surrounding objects.

In a similar design, the knife blade has been slideably coupled such that it can translate relative to the handle to be either exposed for cutting or retracted completely within the handle for storage and safety. A button on the top of the handle allows one to actively select whether the knife blade is exposed or retracted. Utility knives having this configuration are typically long, bulky and hard to handle. Manipulating the utility knife may be difficult because the required angle of cutting may not coincide with proper ergonomic positioning of the human form, and therefore wrists and joints may be overly stressed. This problem is compounded when one has to perform specific cuts repeatedly. Furthermore, when the button mechanism is worn and the utility knife is stored within a pocket the knife blade may be partly exposed and cause injury. Additionally, replacing a knife blade is unnecessarily burdensome as typically the housing of the utility knife must be unscrewed and partially disassembled to allow the exchanging of blades.

In another similar design, the multiblade utility knife may be actuated by a thumbscrew. The thumbscrew is manually operated and requires loosening before the knife is capable of being extended or retracted. Once freed, the thumbscrew mechanism slides lengthwise along the handle to extend or retract the utility knife. The thumbscrew then requires retightening once the utility blade is in the desired position. Typically, both the button mechanism and thumbscrew designs require disassembly of at least a two-piece knife handle to remove and replace the continuous multiblade knife unit.

In still another utility knife design, the knife blade could be automatically retractable by a spring-biasing mechanism. The knife blade automatically retracts into the handle unit upon release of an operating lever. In the retracted position, a spring biases the utility blade carrier unit rearwardly. The carrier unit is released when a user compresses a protruding release mechanism mechanically coupled to the knife blade carrier. The spring releases the utility blade carrier unit, resulting in the extension of the utility blade. Again, these utility knife blade designs typically require manual separation of multiple handle pieces in order to replace worn out or broken blades. In one particular design, the user must remove an outer cover to expose the interior of the knife unit. Removal of the outer cover requires the use of a screwdriver or other tool to dislodge or unscrew the outer cover. Thus, additional tools, time, and handling are required. Such factors all reduce the ease of replacing the knife blade.

Other utility knives include designs that enable users to store a pivotable knife blade in the handle or in a portion of the handle thereof. In these designs, the knife blade is mounted to an arm that pivots upon an axis point connected to one end of the handle and essentially folds open. The knife blade is initially pivoted from a stored position concealed within the handle to an extended position wherein the utility knife is capable of being used as a cutting apparatus. Some designs allow the utility knife to be locked into place by an engagement mechanism. The locking mechanism prevents inadvertent dislodgement of the knife from the extended position. When not in use, the blade is rotated back to a stored position by unlocking the engagement mechanism, if present, by the use of a button mechanism or the like. The knife blade then rotates around the pivot point at one end of the blade handle and back into the base of the handle for safe storage. But, for reasons for stability and safety, the utility blade is generally locked into the rotatable arm. Blade replacement therefore requires disassembly of the handle unit or the rotational arm in order to remove and replace the blade. Another disadvantage to this design is that the knife handle and rotatable utility blade arm include a series of mechanical parts. This increases material, manufacturing, and labor costs to develop and assemble the knife unit. Increasing the complexity of the knife blade retention mechanism increases usage difficulties and expense. Again, knife blade replacement may require complicated operation, manufacturer instructions, or special tools.

Pivotable utility knives that fold typically only have two positions; open and closed. One cannot open and lock the utility knife in any position between being fully opened or fully closed. Many specialized cutting techniques and custom/ergonomic gripping techniques could be used with a folding utility knife that could lock in a plurality of positions. Additionally, changing out knife blades remains overly cumbersome and time consuming with most utility knives.

Accordingly, there is a need for a utility knife that permits quick and easy movement of the blade retainer relative to the handle such that the blade retainer can be locked in a plurality of positions between being either fully opened and closed. Furthermore, there is a need for a quick and easy way to exchange old knife blades for new ones. The present invention fulfills these needs and provides other related advantages.

### SUMMARY OF THE INVENTION

The utility knife of the present invention includes a handle and a blade retainer pivotable relative to the handle. A gear is fixed relative to one of the handle or the blade retainer, and a locking mechanism is associated with the other. The locking mechanism cooperates with the gear to lock the blade retainer in one of a plurality of fixed positions relative to the handle. Being able to lock the blade retainer in a plurality of cutting positions allows the user to ergonomically position the knife in proper orientation with respect to the cutting surface while also properly positioning the handle relative to one's self.

A manually actuable release mechanism is associated with the locking mechanism for unlocking the blade retainer to thereby permit pivotal movement of the blade retainer relative to the handle. The gear is an external gear type with symmetrical teeth, meaning the teeth are shaped and function in the same manner whether the gear is rotating one direction or the other. This is important to allow the release mechanism to ratchet effectively whether rotating when opening or closing.

The blade retainer includes a proximal portion and a distal portion. The distal portion is configured for retaining a knife blade and the proximal portion is pivotal relative to the handle. The blade retainer includes a knife blade locking mechanism which cooperates with a knife blade to lock it in a fixed position relative to the blade retainer. A manually actuable knife blade release mechanism is associated with the knife blade locking mechanism for releasing the knife blade relative to the blade retainer such that an old knife blade can be replaced with a new knife blade. In one embodiment the knife blade release mechanism is movable relative to the handle. When the blade retainer is in a fully open position, the knife blade release mechanism cooperates with the knife blade locking mechanism to release the knife blade for a new one. In another embodiment, the knife blade release mechanism is movable relative to the blade retainer. The knife blade release mechanism cooperates with the knife blade locking mechanism to release the knife blade. Allowing knife blades to be quickly and easy replaced is a critical function when one is performing a multitude of cuts, and accordingly there are a multitude of methods on how to secure and release a knife blade from a blade retainer. This disclosure is not intended to limit the blade retainer to just the specific embodiments described herein.

The handle and gear cooperate to form a channel having a first and a second narrowed/tapered/converging end. The locking mechanism includes a partially toothed first pawl located in the channel. The first pawl is biased into contact in the first converging end, thereby stopping rotation of the handle relative to the blade in the corresponding direction. The locking mechanism includes a partially toothed second pawl located in the channel. The second pawl is biased into contact in the second converging end, thereby stopping rotation of the handle relative to the blade in the opposite corresponding direction. The release mechanism is selectively moveable into engagement with either the first pawl or second pawl to bias the pawl away from the corresponding converging end. The blade retainer is then free to pivot with respect to the handle in that rotational direction. The release mechanism can be pivotable relative to the handle. The bias can be a spring fixed relative between the first and second pawls.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side view of an exemplary utility knife embodying the present invention in a fully opened position;

FIG. 2 is a similar view of the utility knife of FIG. 1 in a fully closed position;

FIG. 3 is a side view of the utility knife of FIG. 2 from the opposite side;

FIG. 4 is a similar view of the utility knife of FIG. 1 in a partially open position;

FIG. 5 is another similar view of the utility knife of FIG. 1 in a partially open position;

FIG. 6 is a similar view of the utility knife of FIG. 1 with the top portion removed;

FIG. 7 is an enlarged view of the locking mechanism taken generally of the area indicated by the line 7-7;

FIG. 8 is a similar view of FIG. 7 showing the selector plate in an all locked position;

FIG. 9 is a similar view of FIG. 7 showing the selector plate in an openable position;

FIG. 10 is a similar view of FIG. 7 showing the selector plate in a closeable position;

FIG. 11 is a side view of the handle of the utility knife with the bottom handle portion removed;

FIG. 12 is a side view of the blade retainer with the bottom blade retainer portion removed;

FIG. 13 is an inside exploded side view of the utility knife of FIG. 1;

FIG. 14 is a perspective view of an exemplary blade retainer;

FIG. 15 is an exploded view of FIG. 14;

FIG. 16 is a further exploded view of FIG. 14;

FIG. 17 is an inverted exploded view of FIG. 16;

FIG. 18 is the internal blade retention mechanism of FIG. 14;

FIG. 19 is a cross-sectional view of FIG. 14 taken along lines 19-19, illustrating the blade in the locked position;

FIG. 20 is a cross-sectional view of FIG. 14 taken along lines 19-19, wherein the blade is unlocked by a release button;

FIG. 21 is a perspective view of an exemplary blade retainer;

FIG. 22 is an exploded view of FIG. 21;

FIG. 23 is another exploded view of FIG. 21;

FIG. 24 is a cross-sectional view of FIG. 21 taken along lines 24-24, illustrating the blade in the locked position;

FIG. 25 is an alternative view of FIG. 21 taken along lines 24-24, wherein the blade is unlocked by a release button;

FIG. 26 is a cross-sectional view of FIG. 21 taken along lines 26-26, illustrating the blade in the locked position;

FIG. 27 is a cross-sectional view of FIG. 21 taken along lines 26-26, wherein the blade is unlocked by a release button;

FIG. 28 is another exemplary blade retainer;

FIG. 29 further illustrates FIG. 28, wherein the rocker arm is in the unlocked position;

FIG. 30 illustrates the rocker arm of FIGS. 28-29 perpendicular to a flat spring, and including a debris release lock;

FIG. 31 is a side view of FIG. 28 taken along lines 31-31, illustrating the blade in the locked position;

FIG. 32 is a side view of FIG. 14 taken along lines 32-32, wherein the blade is in the unlocked position;

FIG. 33 is a perspective view of an exemplary blade retainer;

FIG. 34 is an exploded perspective view of FIG. 33;

FIG. 35 is an inverted exploded perspective view of FIG. 33;

FIG. 36 is a side view of FIG. 33 taken along lines 36-36;

FIG. 37 is a cross-sectional view of FIG. 36 taken along lines 37-37, illustrating the internal alternate rocker arm blade release mechanism in the locked position;

FIG. 38 is another side view of FIG. 36 taken along lines 37-37, wherein the blade is in the unlocked position;

FIG. 39 is a side view of an alternative exemplary blade retainer;

FIG. 40 is a side view of FIG. 39 taken along lines 40-40, illustrating the internal quick release mechanism in the locked position; and

FIG. 41 is a side view of FIG. 39 taken along lines 40-40, wherein the quick release button is in the unlocked position.

### DETAILED DESCRIPTION

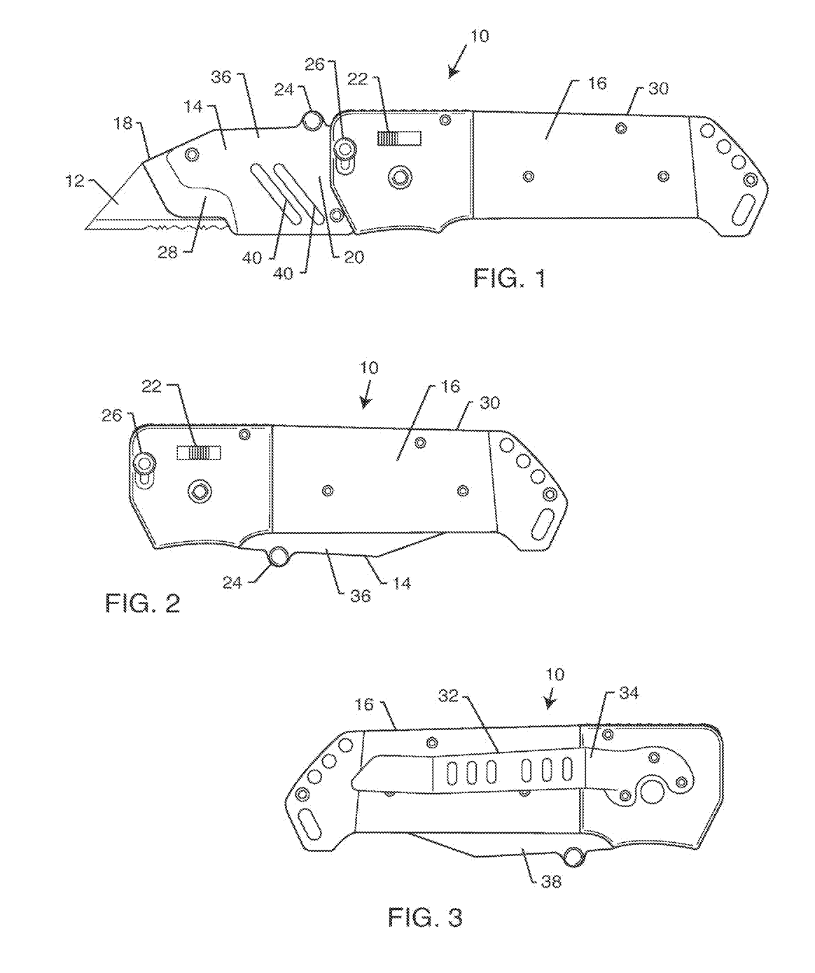

As shown in the exemplary drawings for purposes of illustration, the present disclosure for a utility knife is referred to generally by the reference number 10. Turning now to the representative figures in the specification, FIG. 1 illustrates a utility knife 10 incorporating a knife blade 12. The blade retainer 14 is pivotably coupled to the handle 16. The distal end 18 of the blade retainer 14 is designed to receive and secure the blade 12. The proximal end 20 of the blade retainer 14 is pivotably connected to the handle 16 such that it may pivot open and closed thereby either exposing the blade 12 for use or shielding it for storage.

A manually actuable release mechanism 22 protrudes through a rectangular aperture in the handle 16 and is slidable relative to the handle 16. The release mechanism 22 is manipulated by the user with their hands and fingers. This embodiment of the utility knife 10 is optimized for a right-handed user. With just the right hand, the utility knife 10 may be placed within the palm and the thumb can easily interact with the release mechanism 22 into one of three positions; open, all locked, and closed. The open position allows the blade retainer 14 to pivot in a further open direction. The closed position allows the blade retainer 14 to pivot in a further closed direction. The all locked position means that the blade retainer 14 can't open or close and it is locked relative to the handle 16. The release mechanism 22 in FIG. 1 is in the open position, meaning the blade retainer 14 may pivot open and is prevented from pivoting closed. A picture or image may be transferred directly onto the handle 16 to allow the user to recall how the positions correlate to the functionality of the release mechanism 22.

In FIG. 1 the blade retainer 14 is fully open. FIG. 2 shows the blade retainer 14 in a fully closed position. The blade 12 is securely stored within the handle 16 to prevent inadvertent cutting or injury. The thumb post 24 allows the user to easily open and close the utility knife 10 with a single hand. While this embodiment is oriented for right-handed users, left-handed users can also use the utility knife 10.

It is to be also understood that a left-handed version of the utility knife 10 may be made from the teaching of this disclosure.

A knife blade release mechanism 26 is also slidable relative to the handle 16. When the blade retainer 14 is in a fully open position as in FIG. 1, pressing the knife blade release mechanism 26 allows the knife blade 12 to be removed and a new one installed. The blade release mechanism 26 is also easily activated with the thumb on the right hand by positioning it in close proximity to the other release mechanism 22. A picture or image may be transferred directly onto the handle 16 to allow the user to recall how to release the blade 12. The blade retainer 14 is shaped with a cut-out ledge portion 28 allowing for greater exposure of the blade 12 for cutting. The cut-out ledge portion 28 may also include a beveled edge to further help exposure of the blade 12.

The handle 16 is generally comprised of two halves fixtured together with screws or the like. For convenience of this disclosure, the half with the manually actuable release mechanism 22 protruding through is referred to generally as the top and the other side as the bottom. Accordingly, the top handle portion 30 can be seen in FIGS. 1 and 2, while the bottom handle portion 32 is seen in FIG. 3. A clip 34 is attached to the bottom handle portion 32. The clip 34 allows the utility knife 10 be attached to a pocket, pants, boot or any other suitable article. Similarly, the blade retainer 14 may be described as having a top blade retainer portion 36 and a bottom blade retainer portion 38. Within both the top and bottom blade retainer portions 36, 38 are egress apertures 40. The egress apertures 40 allow one to see whether the blade 12 is fully within the blade retainer 14 and also acts as an exit port for accumulated debris to exit. Allowing debris to exit facilitates a quick and secure attachment each time between the blade retainer 14 and blade 12.

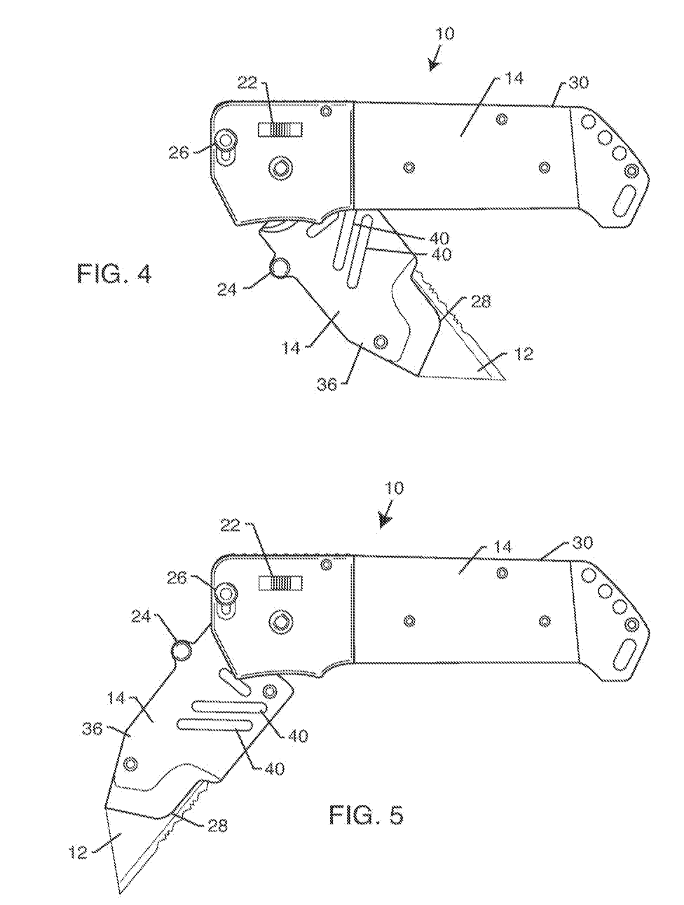

FIGS. 4 and 5 show the utility knife 10 in a partially open position. When the release mechanism 22 is in the all locked position, the blade retainer 14 is prevented from movement in both directions and is fixed relative to the handle 16. Allowing the blade 12 to be fixed at a plurality of positions relative to the handle 16 facilitates the use of new methods of cutting and for better ergonomic positioning. Over time, repeated use of a utility knife can result in injuries and discomfort. Allowing the user to best position the blade 12 for better ergonomics reduces injury and increases the amount of cutting one can accomplish.

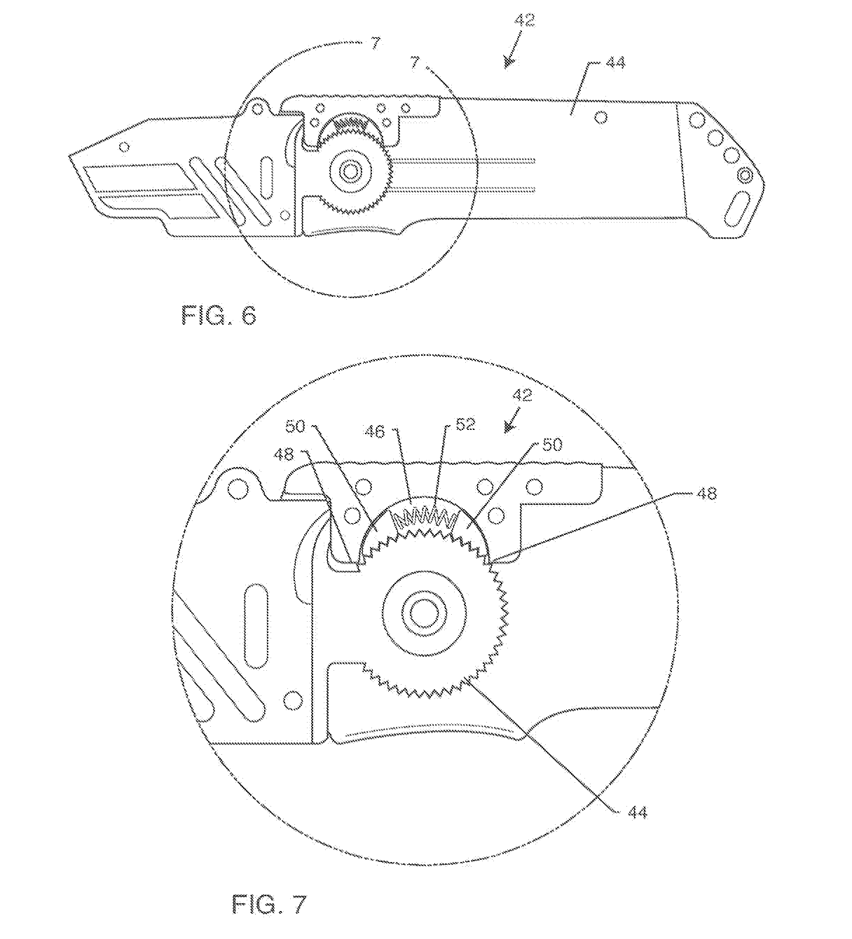

FIGS. 6-10 show an exemplary locking mechanism 42 with the top handle portion 30 and the top blade retainer portion 36 removed. The inside of the bottom handle portion 32 and inside of the bottom blade retainer portion 38 are shown. A gear 44 is fixed relative to the bottom blade retainer portion 38. The gear 44 has external teeth disposed around its perimeter surface. In this embodiment the teeth are symmetrically shaped in that they are the same profile whether viewing from one direction or the other. The gear 44 cooperates with the structure of the bottom handle portion 32 to form a channel 46 with narrowed/tapered/converging ends 48. The channel 46 may take many forms, whereas in this embodiment the channel 46 is comprised of two arcs, one being a partial circle along the gear 44 and the other being oval shaped to cooperate to form the converging ends 48. Inside the channel 46 are two pawls 50 and a biasing element 52, such as a spring. The pawls 50 are partially toothed on one side and on the other side they match the surface of the oval portion of the bottom handle portion 32. The biasing element 52 forces each pawl 50 into its corresponding converging end 48. The bottom blade retainer portion 38 is locked relative to the bottom handle portion 32 due to the interference of the pawls 50 being jammed into the converging ends 48.

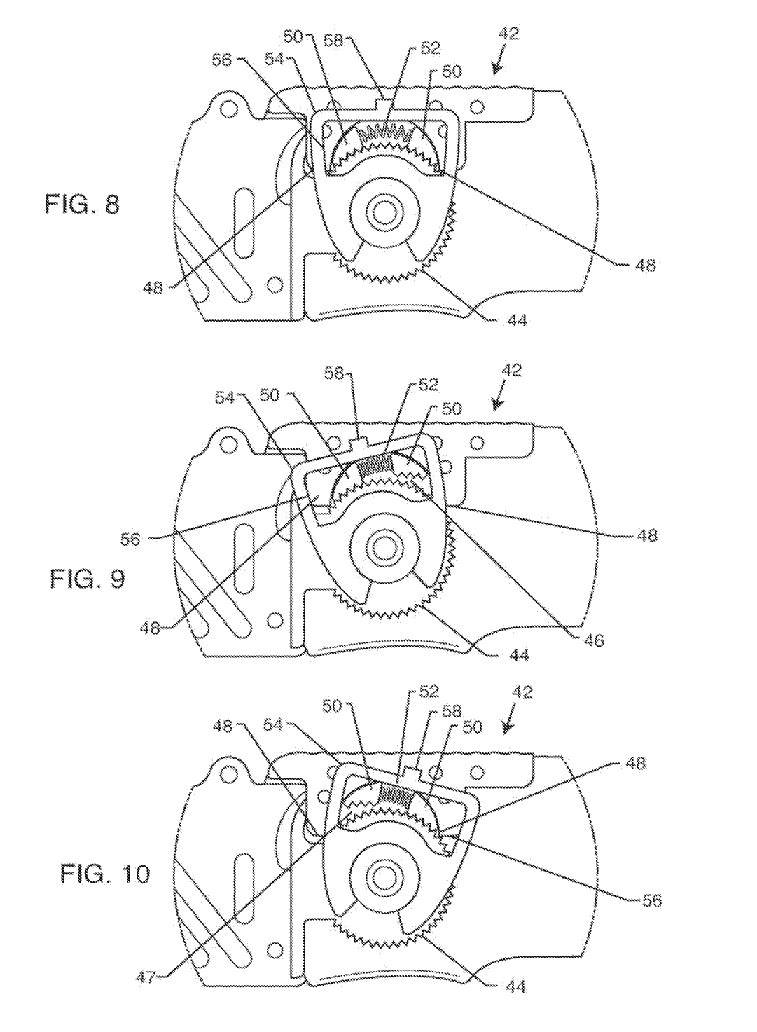

The channel 46 has the same width throughout, or in other words the width of the gear 44 is the same as the width of the bottom handle portion 32 which forms the converging ends 48. However, the pawls 50 are slightly larger in width, such that they protrude outside the boundaries of the channel 46. The pawls 50 are then able to be engaged and manipulated while still inside the channel 46. FIGS. 8-10 show the same view as in FIG. 7 now with a selector plate 54. Selector plate 54 pivots about the same axis as does the gear 44. The selector plate has an aperture 56 that encompasses both pawls 50. The edges of the pawls 50 are able to contact the edges of the aperture 56, such that pivotable movement of the selector plate 54 causes one of the pawls 50 to move away from its corresponding converging end 48. The selector plate 54 also has a tab 58 that engages the manually actuable release mechanism 22 corresponding to either the open, all locked, or closed positions.

In FIG. 8, the selector plate 54 is in the all locked position so that it is not engaging either of the pawls 50. The bottom blade retaining portion 38 cannot pivot in any direction relative to the bottom handle portion 32. In FIG. 9, the selector plate 54 is in the open position in that the bottom blade retainer portion 38 is able to pivot in the open direction as the pawl 50 corresponding to preventing rotation in the open direction has been biased away from its corresponding converging end 48. Accordingly, in FIG. 10, the selector plate 54 is in the closed position in that the bottom blade retainer portion 38 is able to pivot in the closed direction as the pawl 50 corresponding to preventing rotation in the closed direction has been biased away from its corresponding converging end 48. From this teaching and to those skilled in the art, many other ratcheting and/or locking mechanisms are possible to lock a blade retainer 14 in a plurality of positions relative to a handle 16, and this disclosure is not intended to limit it just to the variation described herein. For instance, the gear 44 can be fixed relative to the handle 16 and the internal structure accordingly modified. Other variations, combinations and shapes of pawls 50 and channel 46 may also be devised.

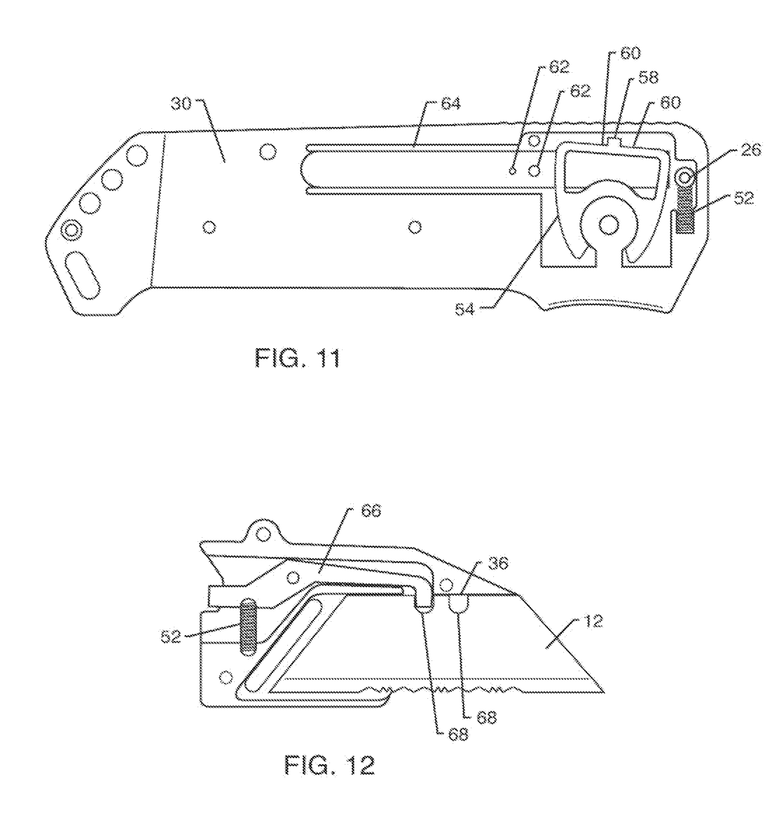

FIG. 11 shows the inside of the top handle portion 30. Selector plate 54 fits within a cavity and pivots about the same axis that corresponds to the gear 44 when the utility knife 10 is assembled. The backside of the manually actuable release mechanism 22 is shown with protrusions 60. When the release mechanism 22 is moved between the open, all locked, and closed positions the protrusions 60 engage the tab 58 causing the selector plate 54 to pivot. The release mechanism 22 can also be biased to remain in its selected position through the use of a ball and detent 62 and linear spring 64. There are many methods of biasing the release mechanism 22 to stay in a selected position, and this disclosure is not intended to limit it to any one type described herein.

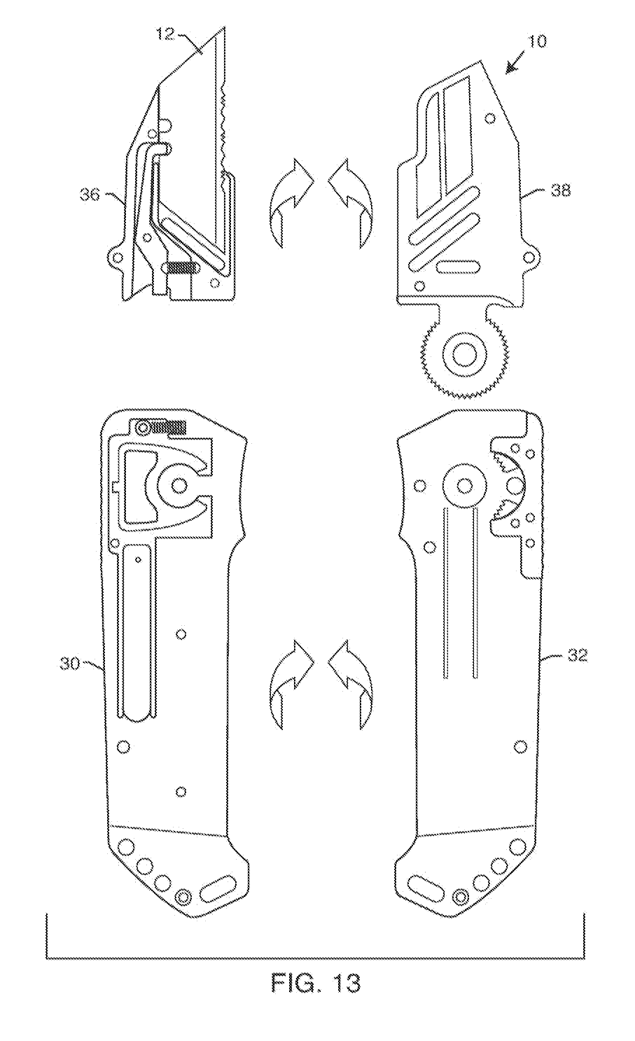

FIG. 12 shows the inside of the top blade retainer portion 32. A trapezoidal knife blade 12 is captured within the structure and also the rocker 66. The rocker 66 pivots about the top blade retainer portion 32 and engages the notches 68 of the blade 12. The rocker 66 is biased in the locked position with a biasing element 52, such as a spring. When the utility blade 10 is assembled and in the fully open position, as seen in FIG. 11 the backside of the knife blade release mechanism 26 engages the rocker 66 to pivot it away from engagement with the notches 68, thereby releasing the blade 12. FIG. 13 shows how the utility knife 10 is assembled and how each half cooperates with the other to provide a ratcheting function and also a blade release function.

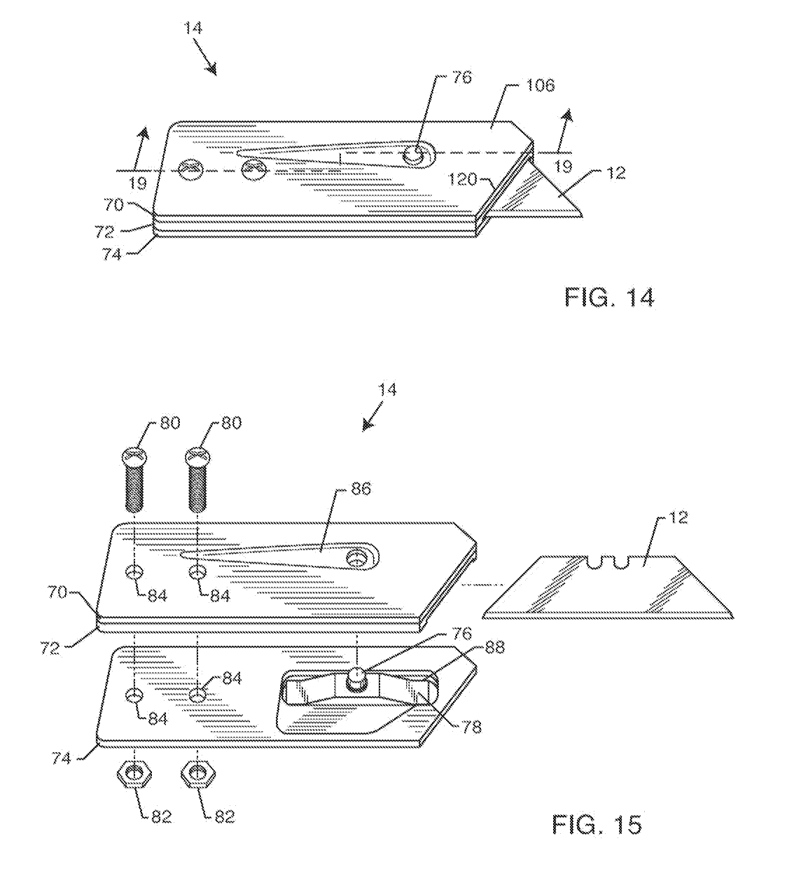

FIGS. 14-41 show different embodiments of locking and releasing the blade 12 within the blade retainer 14. FIG. 14 illustrates a blade retainer 14 incorporating a blade 12. In this embodiment, the blade retainer 14 is constructed of three layers that include a top layer 70, an intermediate layer 72, and a bottom layer 74. It is conceived, however, that two or more layers could be used to form the blade retainer 14 in FIGS. 14-41. A release button 76 further facilitates the release or engagement of the blade 12 within the blade retainer 14 via an actuator spring 78.

For the button 76 and the actuator spring 78 to properly function as a release or engagement mechanism, the top layer 70, intermediate layer 72, and the bottom layer 74 must be secured to one another in the form generally shown in FIG. 14. The bottom surface of the top layer 70 is facingly adjacent to the top surface of the intermediate layer 72. The top surface of the bottom layer 74 is thus facingly adjacent to the bottom surface of the intermediate layer 72. As shown in FIG. 14, the intermediate layer 72 is effectively sandwiched between the top layer 70 and the bottom layer 74. As further described herein, this sandwiched configuration in combination with the release button 76 and the actuator spring 78 enable the blade retainer 14 to effectively accept and retain the blade 12.

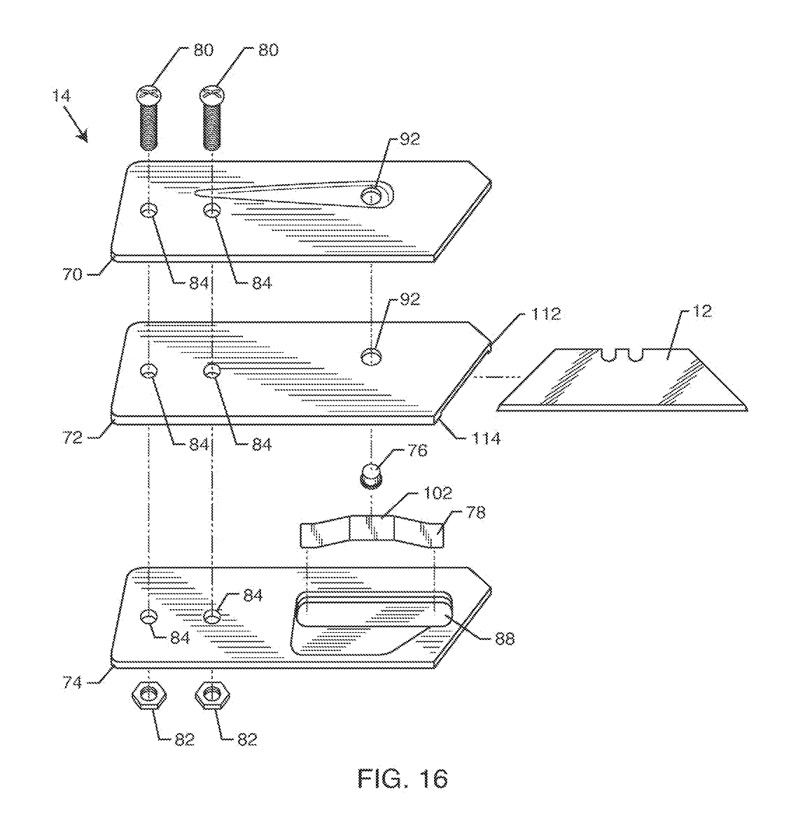

A variety of designs known in the art may be used to retain the top layer 70, the intermediate layer 72, and the bottom layer 74 in the sandwiched configuration of FIG. 14. In FIG. 15, a pair of screws 80 are shown extending vertically through the width of the blade retainer 14 and engaging a pair of nuts 82 to secure the top layer 70, the intermediate layer 72, and the bottom layer 74 together. As better depicted in FIG. 16, the pair of screws 80 extend through a series of holes 84 in the top layer 70, in the intermediate layer 72, and in the bottom layer 74. In this embodiment, the pair of screws 80 may engage the pair of nuts 82 by threaded engagement or any other mechanism known in the art. Additionally, the pair of screws 80 and the pair of nuts 82 may be replaced by other securement devices having a similar function that are known in the art. Such securement devices might include clips, clamps, springs, bolts, rivets or welds. Additionally, it is conceived that chemical adhesives could be used to bind the bottom surface of the top layer 70 to the top surface of the intermediate layer 72 and to bind the top surface of the bottom layer 74 to the bottom surface of the intermediate layer 72. Thus, eliminating the need of a mechanical device. The important aspect of this sandwiched formation is that the release button 76 and the actuator spring 78 are tensioned against one another.

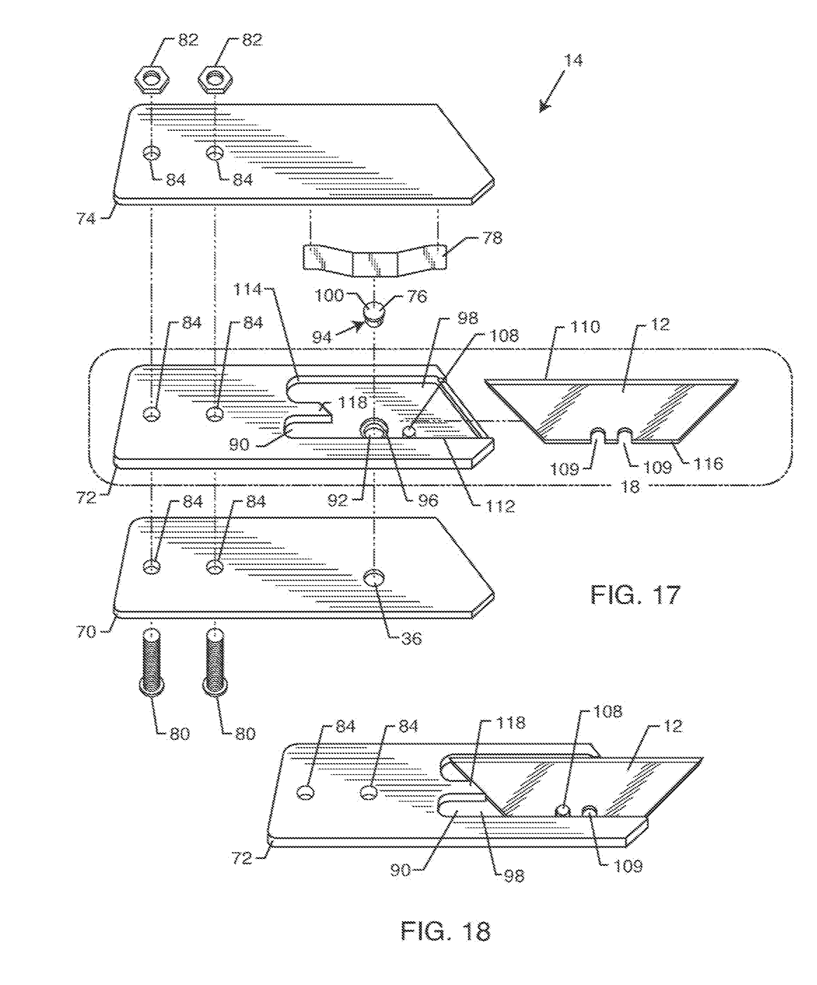

The blade retainer 14 as shown in FIG. 15 illustrates the placement of the release button 76 with respect to the actuator spring 78. A groove 86 is etched into the top surface of the top layer 70 to provide ample fingertip engagement with the release button 76. The actuator spring 78 resides in a spring channel 88 (best shown in FIG. 16) and a spring guide 90 (best shown in FIG. 17) and is used to bias the release button 76 in an upward position. The release button 76 extends through a pair of release button holes 92 to protrude out from the top surface of the top layer 70 in the groove 86. The actuator spring 78 maintains the release button 76 in this protruding position. The combination of the release button 76 and the actuator spring 78 is the mechanism that locks or unlocks the blade 12 from the blade retainer 14.

As shown in FIG. 17, the release button 76 has a retaining lip 94 that engages a retaining ledge 96 located beneath the surface of a blade channel 98. A head portion 100 of the release button 76 is preferably flush with the surface of the blade channel 98. Before the blade 12 is inserted into the blade channel 98, the head portion 100 of the release button 76 contacts a top surface 102 of the actuator spring 78. The actuator spring 78 resides in and is retained by the spring channel 88 in the bottom layer 74. The spring channel 88 prevents movement of the actuator spring 78 during use or transportation of the blade retainer 14. The corresponding spring guide 90 in the intermediate layer 72 allows the actuator spring 78 to extend into a portion of the blade channel 98 for proper retainment of the blade 12 within the blade channel 98. The spring guide 90, like the spring channel 88, helps locate and prevent dislodgment of the actuator spring 78 during use or transportation. The top surface 102 of the actuator spring 78 is facingly adjacent to the head portion 100 of the release button 76. In this configuration, the release button 76 is pushed up by the actuator spring 78 through the release button holes 92 in the intermediate layer 72 and the top layer 70. The release button 76 is maintained in this upward position as protruding through the top surface of the top layer 70 and the groove 86 when the blade retainer 14 is fully assembled.

As the blade 12 is inserted into the blade channel 98, the head portion 100 of the release button 76 and the top surface 102 of the actuator spring 78 are separated by the blade 12. When fully inserted, the blade 12 is wedged between the release button 76 and the actuator spring 78. In a particularly preferred embodiment, the top surface 102 of the actuator spring 78 is formed by a radiused edge to facilitate the insertion of the blade 12. Furthermore, the head portion 100 of the release button 76 is also preferably rounded to ease the insertion of the blade 12. But, a variety of spring and release button designs could be used pending insertion of the blade 12 is not prevented. Once inserted, the blade 12 is substantially flush to the bottom surface of the blade channel 98, as best shown in FIG. 18. Release of the blade 12 is facilitated by depression of the release button 76.

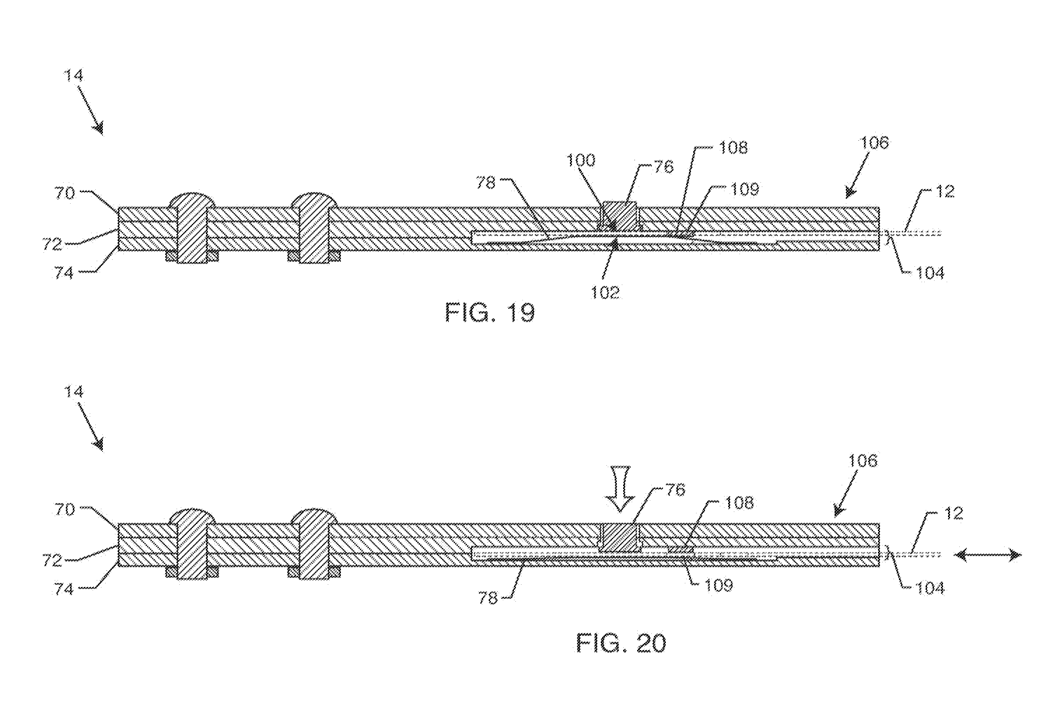

Protrusion of the release button 76 through the top surface of the top layer 70 enables external fingertip engagement by a user. The groove 86 formed in the top surface of the top layer 70 enables a user to depress the release button 76 by applying downward pressure thereon and thereafter effectively compressing the actuator spring 78 thereunder. Depression of the release button 76 from an initial position (FIG. 19) to a depressed position (FIG. 20) is the basis of the quick release mechanism that unlocks the blade 12 from within the blade channel 98 in the embodiments of FIGS. 14-20.

Insertion of the blade 12 into the blade channel 98 does not require depression of the release button 76. A user may simply slide the blade 12 into an insertion slot 104 (FIGS. 19 and 20) formed on a front end 106 of the blade retainer 14 between the intermediate layer 72 and the bottom layer 74. As best shown in FIG. 19, once the blade 12 is fully inserted into the blade channel 98, the blade 12 is wedged between the top surface 102 of the actuator spring 78 and the head portion 100 of the release button 76. In this position, the blade 12 engages and is retained by a knob 108 (FIG. 17). The knob 108 is configured to engage any one of a pair of engagement slots 109 formed on one side of the blade 12. In the embodiment of FIG. 17, the blade 12 is configured in a trapezoidal shape such that the engagement slots 109 are located opposite a blade edge 110. As shown in FIG. 19, one of the engagement slots 109 fits snuggly into and is retained by the knob 108. It is contemplated in the present disclosure that the knob 108 and the engagement slots 109 could comprise a variety of shapes, sizes, or configurations, including multiple knobs. The important aspect is that there is a mechanism to retain the blade 12 in a substantially ridged position when inserted into the blade retainer 14 via the release button 76 and the actuator spring 78.

When the blade 12 is fully inserted into the blade channel 98 and retained by the knob 108, the user should not experience substantial movement of the blade 12. In such a configuration, the blade 12 fits snugly within the housing of the blade channel 98. FIG. 18 is an exemplary illustration of the blade 12 situated in the blade channel 98 as retained by the knob 108 in engagement with one of the engagement slots 109. The blade channel 98 further includes a base guide edge 112 and a blade side guide edge 114 configured to fit the shape of the blade 12. When inserting the blade 12 within the insertion slot 104, the base guide edge 112 and the blade side guide edge 114 reside substantially parallel to and adjacent to a base side 116 and the blade edge 110, respectively, of the blade 12. Furthermore, an end stop 118 is angled to receive one side of the trapezoidal blade 12 to ensure proper location and engagement of at least one of the engagement slots 109 with the knob 108.

FIG. 19 illustrates the blade 12 as fully inserted into the blade retainer 14. The blade 12 fits snuggly between the actuator spring 78 and the release button 76 in the blade channel 98. One of the engagement slots 109 is effectively retained by the knob 108. In this configuration, the blade retainer 14 is in operational use.

Releasing the blade 12 from the blade retainer 14 consists of a single disengagement step. Pressure is exerted along the directional arrow in FIG. 20 such that the release button 76 is depressed against the blade 12 and into the body of the blade channel 98. Accordingly, the actuator spring 78 also depresses to facilitate disengagement of the engagement slot 109 from the knob 108. In this position, the top of the blade 12 clears the bottom of the knob 108. The blade 12 is thus freely movable horizontally along the lines located at the front end 106 of the blade retainer 14. In this disengaged configuration, a user may easily remove the blade 12 from the blade retainer 14 by simply grasping and pulling the blade 12 from the insertion slot 104. Once the blade 12 is removed, another new knife blade may be inserted or the blade retainer 14 could be safely stowed without a knife blade for future use.

Additionally, the front end 106 of the blade retainer 14 is configured for maximum exposure of the blade edge 110. As best shown in FIG. 14, the front end 106 contains an angled portion 120 that runs back along the length of the blade edge 110. The angled portion 120 provides additional exposure of the blade edge 110, thereby increasing cutting surface and efficiency of the blade retainer 14 of the present invention. It is also conceived in the present invention that the configuration of the angled portion 120 could include multiple designs or shapes to maximize exposure of the blade edge 110. Other alternate embodiments of this concept are further illustrated below.

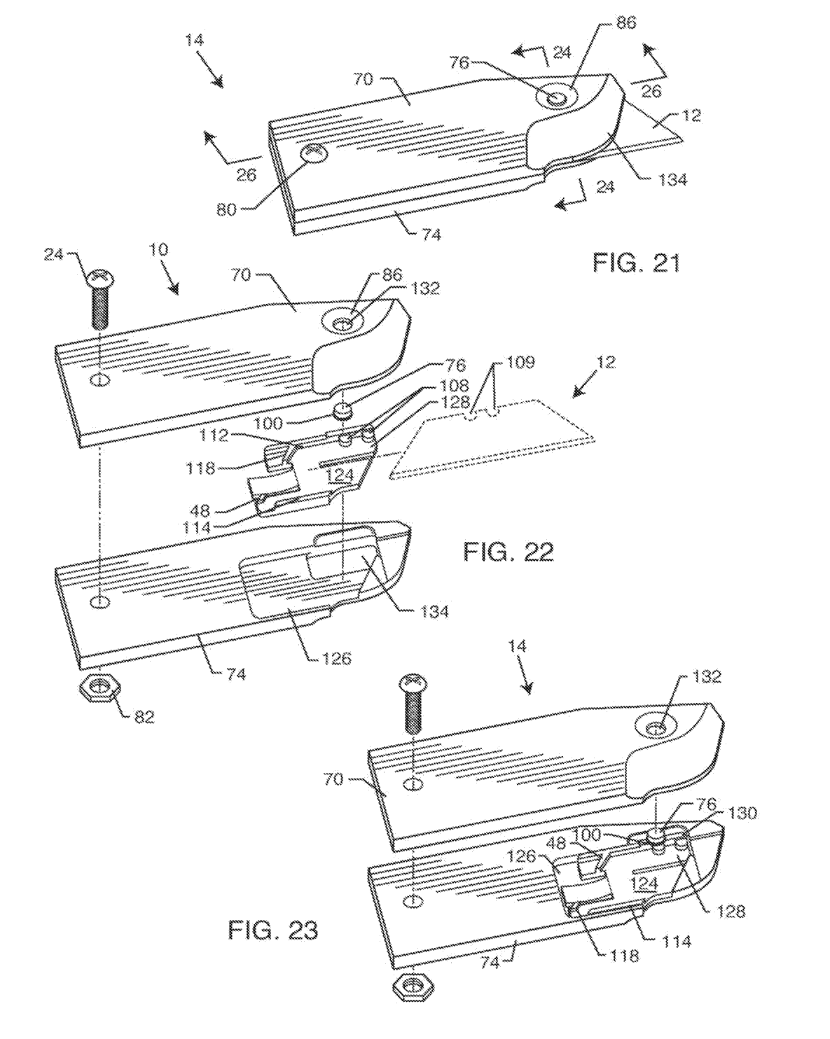

FIGS. 21-27 disclose an alternative embodiment of the blade retainer 14 incorporating a quick release mechanism. In FIG. 21, the top layer 70 is connected directly to the bottom layer 74 by the screw 80 and the nut 82 combination (FIG. 22). The top layer 70 and the bottom layer 74 could also be connected by any of the mechanisms or adhesives already described. In this embodiment, the blade retainer 14 has a similar, yet shorter, groove 86 of which the release button 76 is accessible for fingertip engagement. Many different designs of the groove 86 are capable of being incorporated into the present invention pending adequate fingertip engagement is provided to actuate the corresponding spring. Additionally FIG. 21 discloses a radiused edge 122 that provides ample exposure of the blade edge 110 of the blade 12, similar to the angled portion 120 illustrated in FIG. 14.

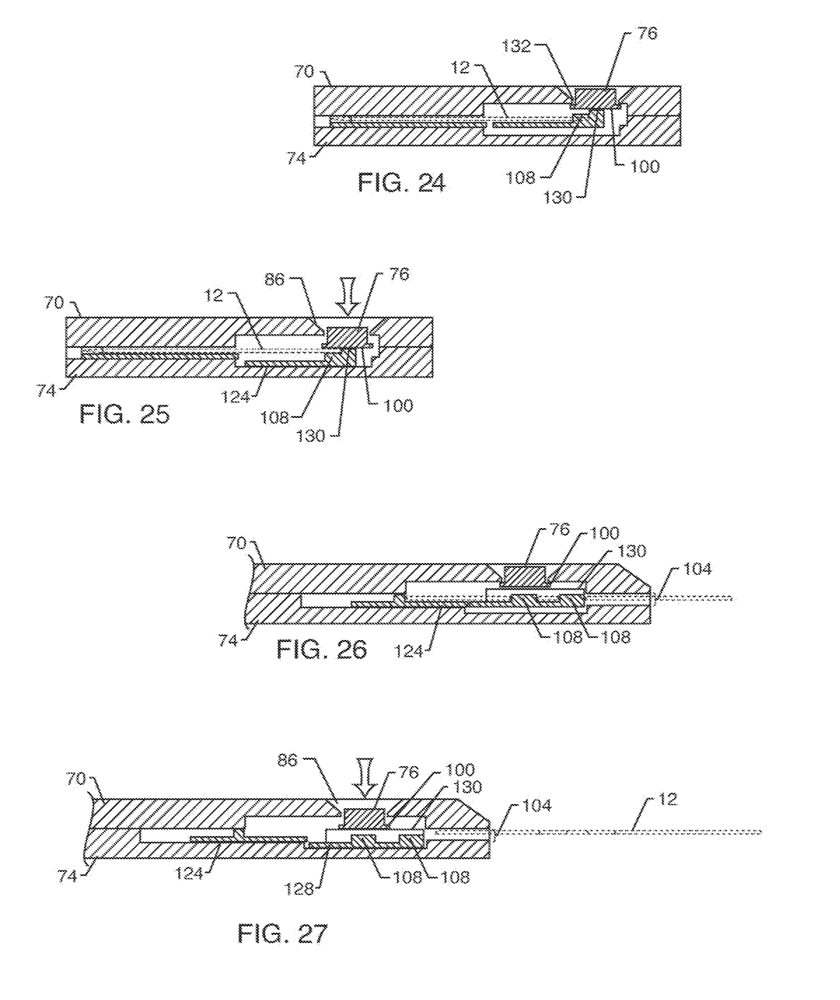

FIG. 22 illustrates an exploded view of the blade retainer 14 incorporating the alternative quick release mechanism. The blade retaining mechanism shown in FIG. 22 is a clip 124 that is sandwiched between the top layer 70 and the bottom layer 74. The clip 124 resides in a clip channel 126 formed into the bottom layer 74. A spring arm 128 is integrally formed from the clip 124. The spring arm 128, as shown in FIG. 22 has the two knobs 108 formed therein to retain the blade 12 via the engagement slots 109. The two knobs 108 protrude from the clip 124 and are adjacent to an upper rail 130. As best shown in FIG. 24, the top portion of the upper rail 130 biases the head portion 100 of the release button 76 in an upward position. The release button 76 extends through a release aperture 132 formed in the top layer 70 and protrudes from the surface of the groove 86 for fingertip engagement. The release button 76 is effectively held in place by the spring arm 128. FIG. 23 better illustrates the placement of the clip 124 within the clip channel 126 of the bottom layer 74 for biasing the release button 76 in this upward position. When the clip 124 is seated within the clip channel 126 untensioned, the spring arm 128 is substantially parallel to the base of the clip channel 126.

In operation, the release button 76 is depressed (shown best between FIGS. 24 and 125 and between FIGS. 26 and 27) such that the head portion 100 of the release button 76, as continually mated to the top surface of the upper rail 130, depresses the spring arm 128 into a spring arm channel 134 (FIG. 22). The groove 86 is configured to provide sufficient fingertip engagement to enable adequate depression of the release button 76 and the corresponding spring arm 128. Adequate depression requires that the spring arm 128 is depressed far enough into the spring arm channel 134 to disengage the knobs 108 from the engagement slots 109 of the utility blade 12. FIGS. 25 and 27 represent the blade 12 in the unlocked position such that the blade 12 can either be slidingly inserted or slidingly released from the clip 124.

In FIGS. 26-27, the blade 12 is inserted through the insertion slot 104 formed between the top layer 70 and the bottom layer 74. To insert the blade 12, the release button 76 and the spring arm 128 are depressed into the spring arm channel 134 such that the knobs 108 are deflected below the surface level of the slide clip channel 126. Thus, the blade 12 can be easily inserted or removed from the insertion slot 104 without interference with the knobs 108. Upon insertion, the blade 12 is guided into the clip 124 by the base guide edge 112 and blade side guide edge 114 show best in FIGS. 22-23. The end stop 118 laterally aligns the utility blade 12 such that the pair of knobs 108 engage the engagement slots 109 when the release button 76 is no longer depressed and the spring arm 128 returns to an untensioned position.

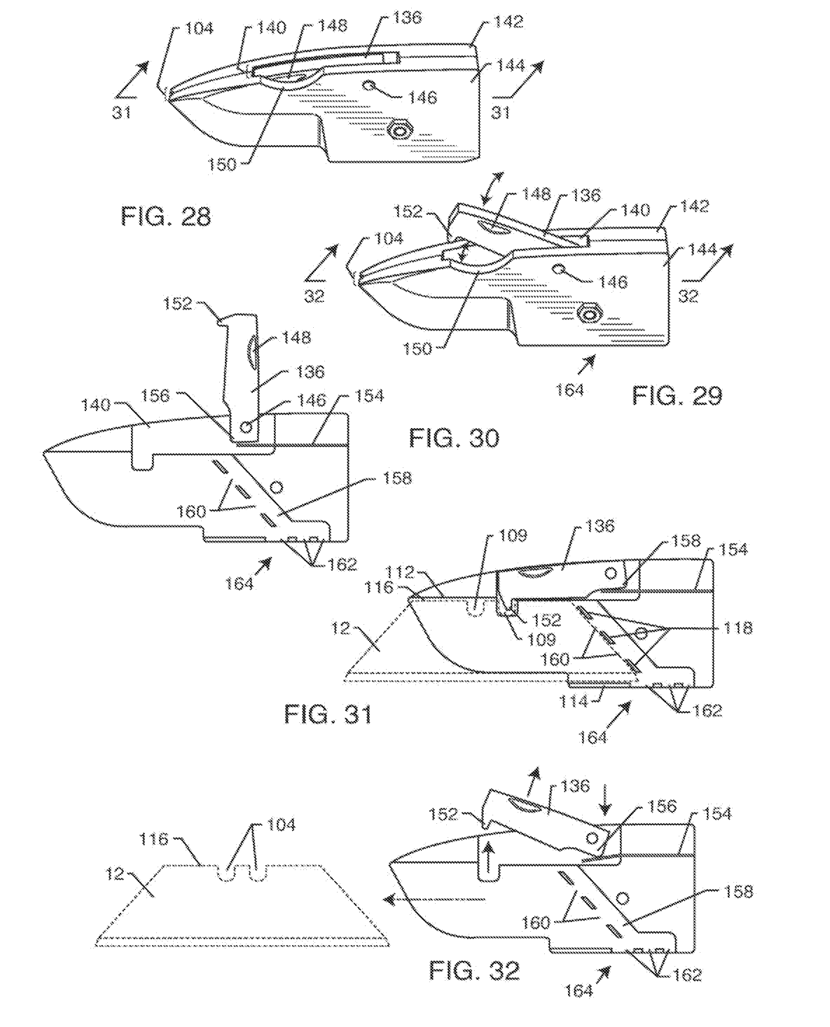

FIGS. 28-32 illustrate another alternative embodiment of the locking and releasing mechanism of the present invention. FIGS. 28-30 illustrate the motion of a rocker arm 136 disposed within a slot 140 formed from the assembly of a first body half 142 and a second body half 144. A pivot pin 146 is concentrically located within an aperture formed in the first body half 142 (not shown), an aperture formed in the second body half 144 (not shown) and an aperture formed in the rocker arm 136 (also not shown). The rocker arm 136 rotates within the slot 140 around the pivot pin 146. To move the rocker arm 136 from a locked position (FIGS. 28 and 31) to an unlocked position (FIGS. 29-30 and 32), an engagement slot 148 is utilized for fingernail engagement to rotate the rocker arm 136 upwardly along the arrows in FIG. 29. A recess 150 formed in the second body half 144 provides adequate fingernail engagement with the engagement slot 148.

The quick release mechanism of FIGS. 28-32 enables a user to insert the blade 12 by either first moving the rocker arm 136 to an unlocked position or by simply inserting the blade 12 into the insertion slot 104. Without first unlocking the rocker arm 136, users may insert the blade 12 into the insertion slot 104 by angling a portion of the blade 12 within the insertion slot 104. The rocker arm 136 is pushed upward slightly by the base side 116 of the blade 12 to enable the engagement slots 109 to slide into place without the obstruction of a retainment finger 152 located at the end of the rocker arm 136.

Once the blade 12 is inserted into the insertion slot 104 and effectively retained by the retainment finger 152 of the rocker arm 136, the blade 12 cannot be removed without manually rotating the rocker arm 136 to the unlocked position via fingernail engagement through the engagement slot 148. Manual rotation of the rocker arm 136 is required because the retainment finger 152 is held in tension by a flat spring 154. When the rocker arm 136 is in the locked position, the flat spring 154 resides substantially untensioned in a slot formed as part of the first body half 142 and the second body half 144. As the rocker arm 136 is rotated to an unlocked position, an edge 156 of the rocker arm 136 rotates and deflects a portion of the flat spring 154 downwardly. In the configuration shown in FIG. 29, the flat spring 154 is tensioned and applies a force to the rocker arm 136 at the contact point with the edge 156. This force creates counter-clockwise rotational moment on the rocker arm 136. The rotational moment will rotate the rocker arm 136 back into the locked position of FIG. 31 with any displacement of the flat spring 154. Hence, the rocker arm 136 is retained in the locked position absent reactant forces to maintain the rocker arm 136 in the unlocked position.

Although, as shown in FIG. 30, if the rocker arm 136 is rotated to a position substantially perpendicular to the flat spring 154, the edge 156 loses contact with the flat spring 154. In FIG. 30, the flat spring 154 no longer exerts a rotational force on the rocker arm 136. Thus, the rocker arm 136 may reside in the substantially perpendicular position of FIG. 30 without rotating back to the locked position as previously described. In fact, the flat spring 154 now assumes the opposite role. The flat spring 154 will exert a force at the contact point of the edge 156 that creates a clockwise moment on the rocker arm 136. This opposite rotational moment will attempt to retain the rocker arm 136 in the perpendicular, unlocked position. But, once the rocker arm 136 is rotated beyond a threshold point, the flat spring 154 will again exert the counter-clockwise rotational force on the rocker arm 136 wherein the rocker arm 136 snaps back into the locked position.

Location of the blade 12 within the insertion slot 104 of the blade retainer 14 is accomplished in a similar manner as the previous embodiments. As illustrated in FIG. 18, the base guide edge 112 and the corresponding blade side guide edge 114 vertically locate the blade 12 within the insertion slot 104. Additionally, the end stop 118 locates the blade 12 horizontally within the insertion slot 104. Once aligned, the retainment finger 152 is easily engageable with the engagement slot 109.

As an additional feature, FIGS. 30-32 illustrate a debris release slot 158 located behind the end stop 118. During the use of the blade retainer 14, debris can get caught in the insertion slot 104, especially when the blade 12 is inserted or removed. If the end stop 118 did not contain a series of gaps 160, debris would get pushed back within the body of the blade retainer 14. When a new blade 12 is inserted, the debris is trapped and even compacted against the end stop 118. Removal of the compacted debris necessarily requires the step of disassembling the blade retainer 14. The series of gaps 160 as illustrated in FIGS. 30-32 provide access to the debris release slot 158 located behind the end stop 118. As the blade 12 is inserted into the insertion slot 104, any debris residing within the insertion slot 104 is pushed toward the end stop 118 and through the series of gaps 160 and into the debris release slot 158. Debris that would normally become trapped now resides in the debris release slot 158. Here, the debris will not restrict easy and full insertion of the blade 12 within the insertion slot 104. The debris exits through a series of exit points 162 formed on a bottom portion 164 between the first body half 142 and the second body half 144. Debris that would otherwise jam in the insertion slot 104 and prevent insertion of the blade 12 therein is effectively flushed out through the debris release slot 158 without disassembly the first body half 142 from the second body half 144.

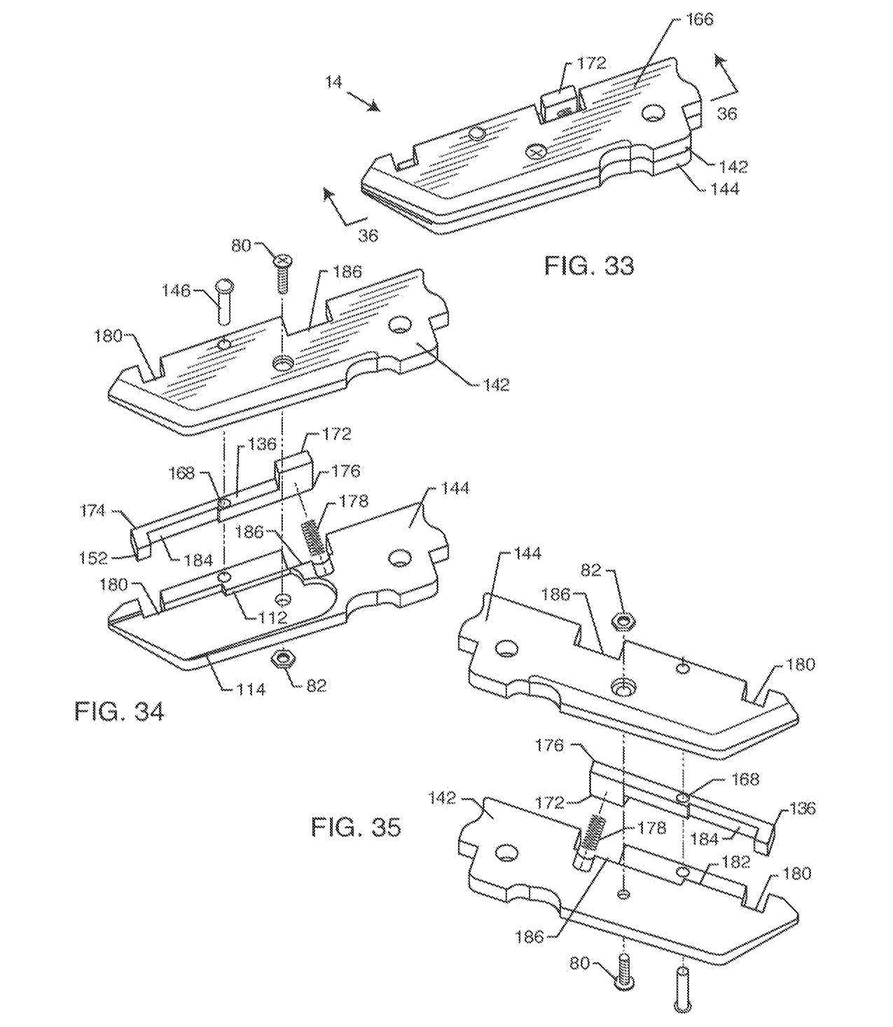

FIGS. 33-38 disclose another alternative embodiment of the present invention embodying a locking and releasing mechanism of a blade retainer 14. In FIG. 33, the rocker arm 136 resides within a slot (not shown) formed between the first body half 142 and the second body half 144. The first body half 142 and the second body half 144 are held together by any of the mechanical mechanisms or chemical adhesives as previously disclosed, including the combination of the screw 80 and the nut 82 shown in FIGS. 34-35. The rocker arm 136 includes a pivot aperture 168 which pivot pin 146 is concentrically located.

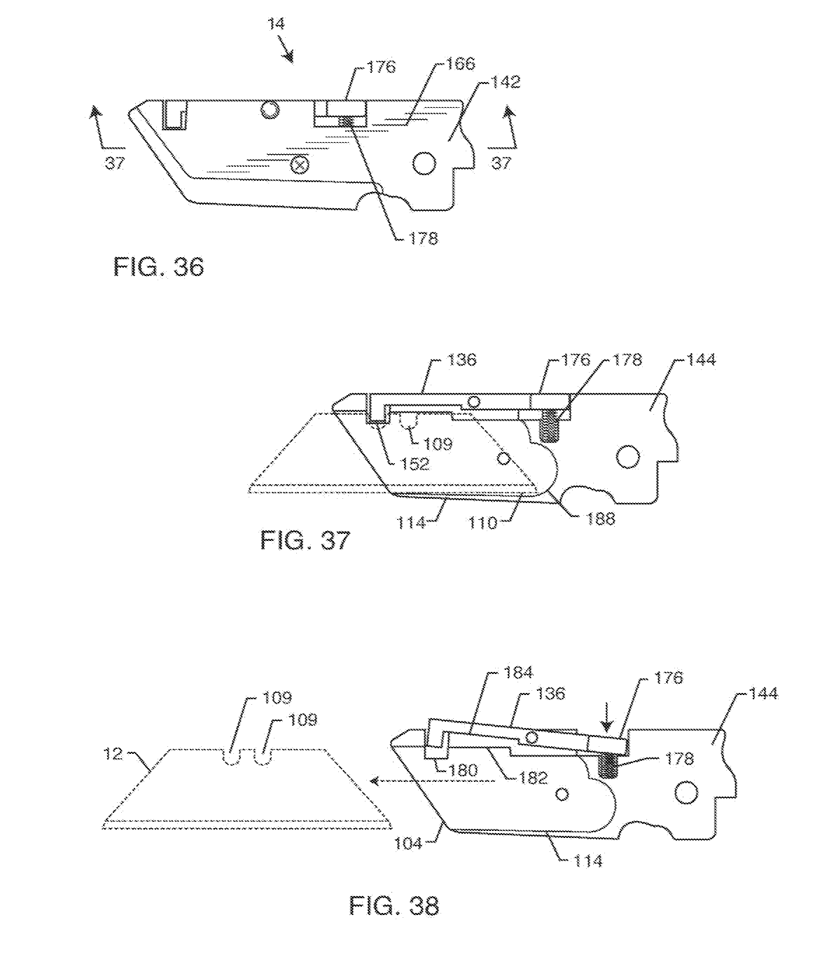

The rocker arm 136 has a first end 174 including the retainment finger 152 and a second end 176 including a button protrusion 172. The retainment finger 152 resides within a retainment finger slot 180 formed in the first body half 142 and formed in the second body half 144. When the knife blade retainment head 166 is fully assembled, as in FIG. 36, a coil spring 178 exerts a vertical force on the second end 176 of the rocker arm 136. This vertical force creates a counter-clockwise rotational moment on the rocker arm 136 around the pivot pin 146. In accordance with this counter-clockwise rotational moment, the first end 174 of the rocker arm 136 is forced within the retainment finger slot 180. A horizontal base 182 is preferably adjacent and flush with a bottom area 184 of the retainment finger 152. It is the horizontal base 182 that maintains the rocker arm 136 in a substantially horizontal position.

When the rocker arm 136 is in this horizontal position, as shown in FIGS. 36-37, the coil spring 178 remains tensioned. Absent the horizontal base 182, the coil spring 178 would continue rotating the rocker arm 136 about the pivot pin 146 until the coil spring 178 reached an untensioned state. The coil spring 178 maintains enough tension when the rocker arm 136 is in the horizontal position such that the retainment finger 152 retains the blade 12 within the insertion slot 104 via at least one of the engagement slots 109 as shown in FIG. 37. In FIG. 38, the coil spring 178 is further depressed and tensioned by applying the external force along the illustrated arrow. A pair of button gaps 186 (best shown in FIGS. 34-35) formed in the first body half 142 and formed in the second body half 144 provide adequate fingertip engagement of the second end 176 to adequately depress the button protrusion 172. Further depression of the coil spring 128 rotates the rocker arm 136 clockwise. The retainment finger 152 is effectively raised out of the blade channel 98. The blade 12 is then freely movable laterally within the insertion slot 104. Absent pressure exerted along the arrow in FIG. 38, the rocker arm 136 would return to the substantially horizontal position as shown in FIG. 37. The rocker mechanism of FIGS. 28-41 has the same functionality regardless whether rotation of the rocker arm 136 is clockwise or counter-clockwise.

As in previous embodiments, the base guide edge 112 and the blade side guide edge 114 locate the blade 12 within the insertion slot 104. In embodiment of FIG. 37, a radius edge stop 188 contacts a portion of the blade edge 110 to locate the blade 12 horizontally within the insertion slot 104. The combination of the base guide edge 112, the blade side guide edge 114, and the radius edge stop 134 guide the placement of the engagement slots 109 such that when the blade 12 is fully inserted, the retainment finger 152 engages at least one of the engagement slots 109. The blade 12 thereafter resides snugly within the insertion slot 104.

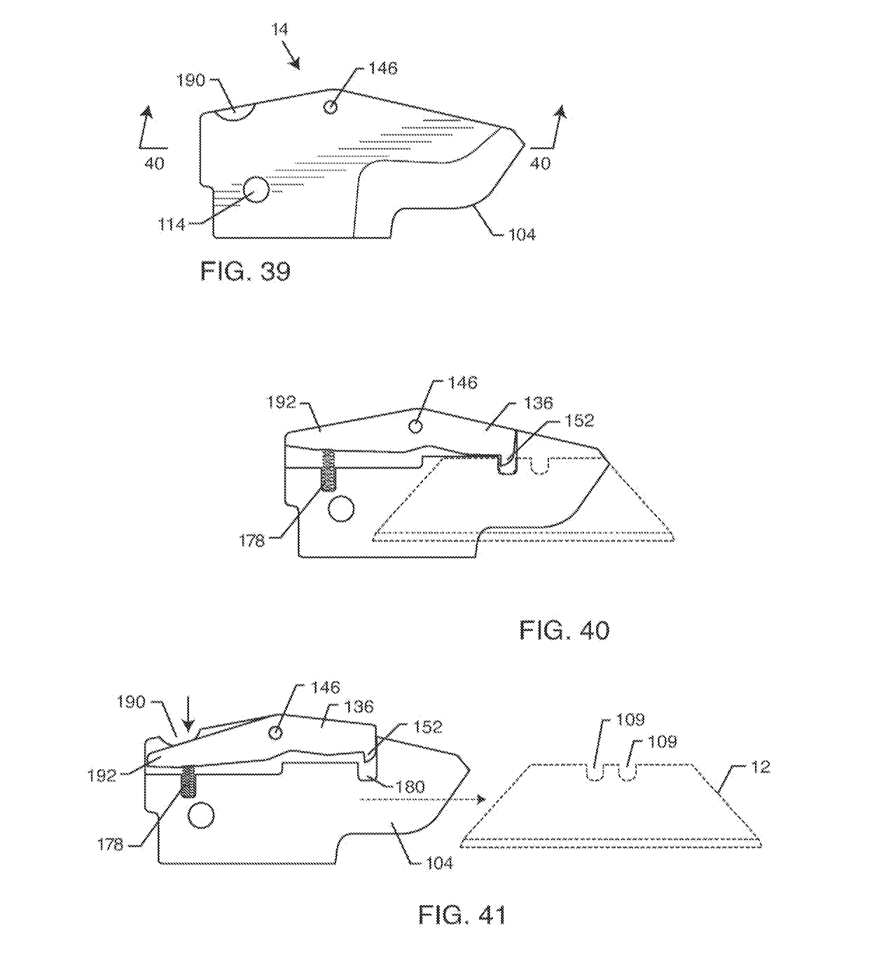

FIGS. 39-41 show an alternative embodiment of the knife blade retaining head 166 of a blade retainer 14 in FIGS. 33-38. As shown in FIGS. 39-41, a recess 190 provides fingertip access to a rear portion 192 of the rocker arm 136. Depression of the rocker arm 136 along the arrow shown in FIG. 41 rotates the rocker arm 136 counter-clockwise. The coil spring 178 is depressed and the retainment finger 152 is raised from within the retainment finger slot 180. The blade 12 is then freely movable for insertion or removal from the insertion slot 104. The retainment finger 152 would no longer engage any one of the engagement slots 109 of the blade 12. Once pressure is released from the rocker arm 136, along the arrow in FIG. 41, the rocker arm 136 rotates back to the position in FIG. 40 along the pivot pin 146.

Although several embodiments have been described in detail for purposes of illustration, various modifications may be made to each without departing from the scope and spirit of the invention. Accordingly, the invention is not to be limited, except as by the appended claims.

1. A utility knife comprising:
a handle;
a blade; and
a blade holder configured to removably secure the blade and movable relative to the handle between a retracted position and an extended operative position, wherein a forward end of the blade holder includes a cut-out ledge portion shaped to expose at least 50% of a cutting edge of the blade when the blade is secured to the blade holder and the blade holder is in the extended operative position.

2. The utility knife according to claim 1, wherein the blade holder fully covers a top edge of the blade opposite the cutting edge, when the blade is secured to the blade holder.

3. The utility knife according to claim 1, wherein the blade is a trapezoidal blade.

4. The utility knife according to claim 1, further comprising a blade release mechanism configured to selectively release the blade from the blade holder.

5. The utility knife according to claim 4, wherein the blade release mechanism comprises a button.

6. A knife comprising:
a blade; and
a blade holder configured to be movably mounted to a handle and to removably secure the blade, wherein the blade holder is shaped and positioned so that less than 50% of a cutting edge of the blade is disposed inside the blade holder when the blade is secured in the blade holder.

7. The utility knife according to claim 6, wherein the blade holder fully covers a top edge of the blade opposite the cutting edge, when the blade is secured to the blade holder.

8. The utility knife according to claim 6, wherein the blade is a trapezoidal blade.

9. The utility knife according to claim 6, further comprising a blade release mechanism configured to selectively release the blade from the blade holder.

10. The utility knife according to claim 9, wherein the blade release mechanism comprises a button.
